(19) United States
(12) Patent Application Publication
(10) Pub. No.: US 2019/0246760 A1
(43) Pub. Date: Aug. 15, 2019

(54) METHOD AND DEVICE FOR PROTECTING A BAG FROM DIRT, GERMS AND GRIME

(71) Applicant: Sandra Stein, West Hills, CA (US)

(72) Inventor: Sandra Stein, West Hills, CA (US)

(21) Appl. No.: 15/897,476

(22) Filed: Feb. 15, 2018

(51) Int. Cl. A45C 13/00; C09J 5/00

(52) U.S. Cl. CPC A45C 13/002; C09J 2433/00; C09J 5/00

(57) ABSTRACT

A method for protecting the bottom of a bag from dirt, germs and grime. A protective film is adhered to release paper to form a protective film unit sheet. The protective film unit sheet is then folded and placed into a pouch. The pouch is then placed into a bag for easy access. When needed, the pouch is removed from the bag. The protective film unit is removed from the pouch and unfolded. The protective film is peeled away from the release paper and the adhesive remains attached to the protective film. The protective film is then adhered to the bottom of a bag to protect the bag from dirt, germs and grime. When finished, the protective film is peeled away from the bag so that the adhesive remains attached to the protective film, leaving the handbag free from unwanted adhesive residue. In a preferred embodiment the protective film is adhered to the bottom of purse to protect the purse from dirt, germs and grime.

The present invention relates to bags, and in particular, to methods and devices for keeping bags free from dirt, germs and grime.

### BACKGROUND OF THE INVENTION

Purses and handbags (such as prior art purse 50 (see FIG. 1)) are very common in society and are used by people throughout the world. Typically, a woman will carry her purse with her throughout the day. Oftentimes, the woman will need to put the purse down. In some cases, it can be difficult to find a clean place to set the purse down.

Carpet protection films with tacky, pressure sensitive adhesives are well known. Provided in a roll, the tacky thin carpet protection film typically includes a polyethylene film that is usually at least 2 mils thick, flexible and strong. One side of the carpet protection film includes a tacky, pressure sensitive adhesive. The user of the carpet protection film commonly will cut from the roll the length of carpet protection film needed. Then the user will place the film on the carpet (tacky side down) to protect the carpet from paint, dirt or other stain causing substances. The pressure sensitive adhesive is tacky so it stays in place as positioned on the carpet. When the user no longer needs the carpet protection film, the user can easily peel it away from the surface of the carpet. When the carpet protection film is pulled from the surface of the carpet, the adhesive remains attached to the carpet protection film rather than the carpet so that the carpet is free from any unwanted residue.

For a carpet protection film to function ideally, the adhesive must be tacky enough to adhere to the carpet so that the film stays in place as positioned on the carpet. The adhesive preferably is such that when the protective film is peeled away from the carpet, the adhesion remains attached to the protective film without leaving residue attached to the carpet. Removable carpet protection films with these characteristics are well known in the prior art and are commonly available from a variety of vendors. For example, Surface Shields, Inc. with offices in Orland Park, Ill. provides a carpet protection film under the trade name of Carpet Shield®, having a formulated acrylic adhesive with an adhesive strength of 17-25 oz/in. Also, ArmorDillo, Inc. with offices in Rochester, N.Y., provides a similar self-adhering carpet protection film (part no. 636391674119).

What is needed is an improved method and device for keeping purses and handbags clean from dirt, germs and grime.

### SUMMARY OF THE INVENTION

The present invention provides a method for protecting the bottom of a bag from dirt, germs and grime. A protective film is adhered to release paper to form a protective film unit sheet. The protective film unit sheet is then folded and placed into a pouch. The pouch is then placed into a bag for easy access. When needed, the pouch is removed from the bag. The protective film unit is removed from the pouch and unfolded. The protective film is peeled away from the release paper and the adhesive remains attached to the protective film. The protective film is then adhered to the bottom of a bag to protect the bag from dirt, germs and grime. When finished, the protective film is peeled away from the bag so that the adhesive remains attached to the protective film, leaving the handbag free from unwanted adhesive residue. In a preferred embodiment the protective film is adhered to the bottom of purse to protect the purse from dirt, germs and grime.

### BRIEF DESCRIPTION OF THE DRAWINGS

FIG. 1 shows a prior art purse.

FIGS. 2-3 show a preferred protective film unit.

FIG. 4 shows a folded protective film unit placed into a pouch.

FIG. 5 shows a protective film being peeled away from release paper.

FIG. 6 shows protective film peeled away from release paper.

FIG. 7 shows protective film adhered to the bottom of a purse for protection.

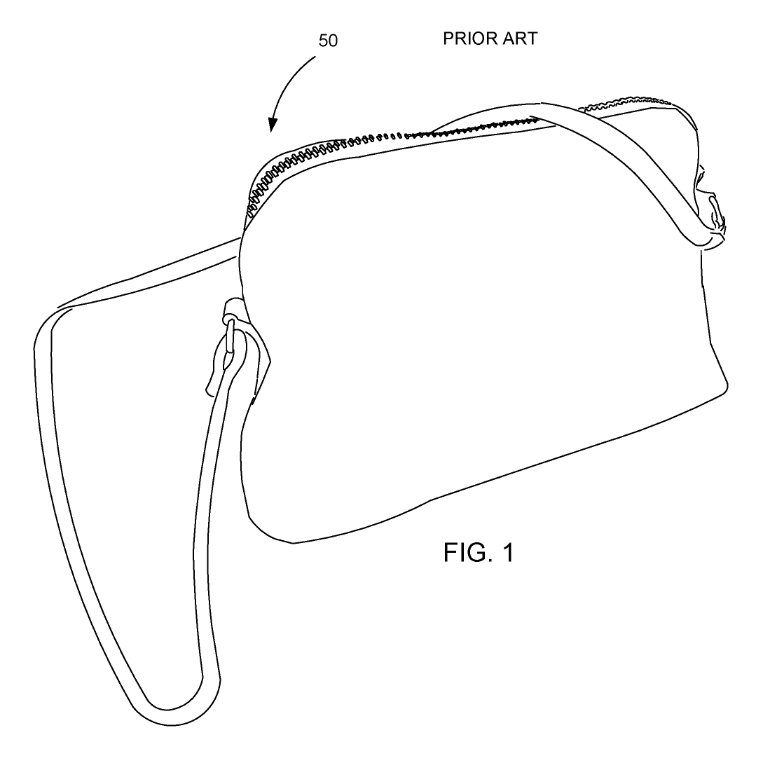

### DETAILED DESCRIPTION OF PREFERRED EMBODIMENTS OF THE PRESENT INVENTION

By utilization of the present invention, a user can easily and conveniently place a self-adhering protective film layer onto the bottom of a purse to protect the purse from dirt and germs. When no longer needed for protection, the user can easily peel off the protective film layer and discard it. When removed, the adhesive from the protective film will preferably remain attached to the protective film leaving the purse free from unwanted residue.

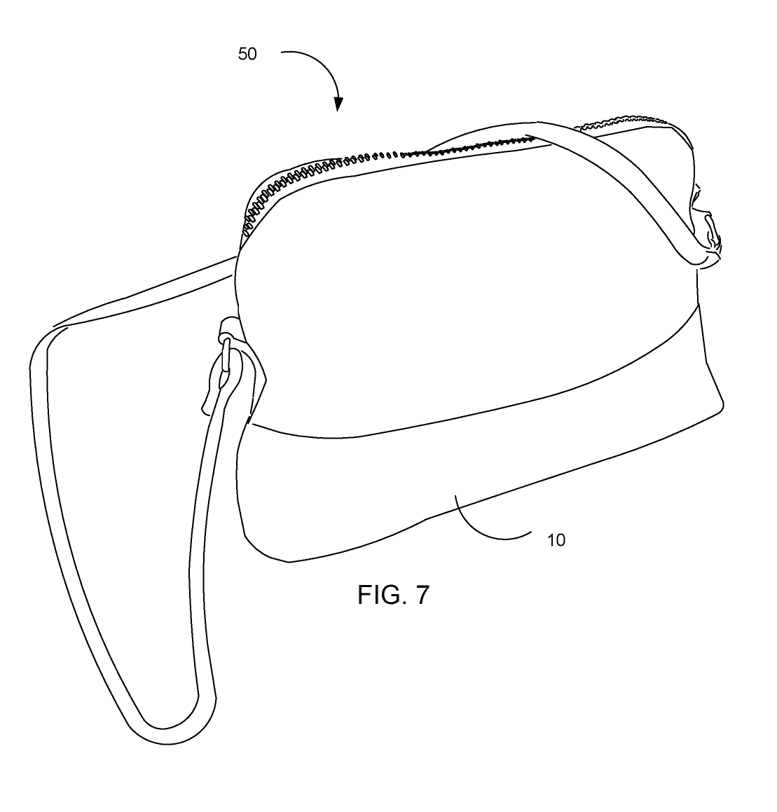

For example, FIG. 7 shows a preferred protective film layer 10 adhered to the bottom of purse 50. Protective film layer 10 utilizes a tacky, reusable, pressure sensitive adhesive 15 to adhere itself to the underside of purse 50 to protect it from germs and dirt. In a preferred embodiment, when protective film 10 is removed from the purse, adhesive 15 will remain attached to protective film 10 so that no sticky residue is left attached to the purse.

### Manufacture of a Preferred Protective Film Unit

Protective film layer 10 is adhered to release paper 12 utilizing tacky, reusable, pressure sensitive adhesive 15 to form protective film unit sheet 20. In the preferred embodiment shown, protective film layer 10 is a transparent, flexible, thin, strong polyethylene film that is approximately 2 mil thick (FIG. 3).

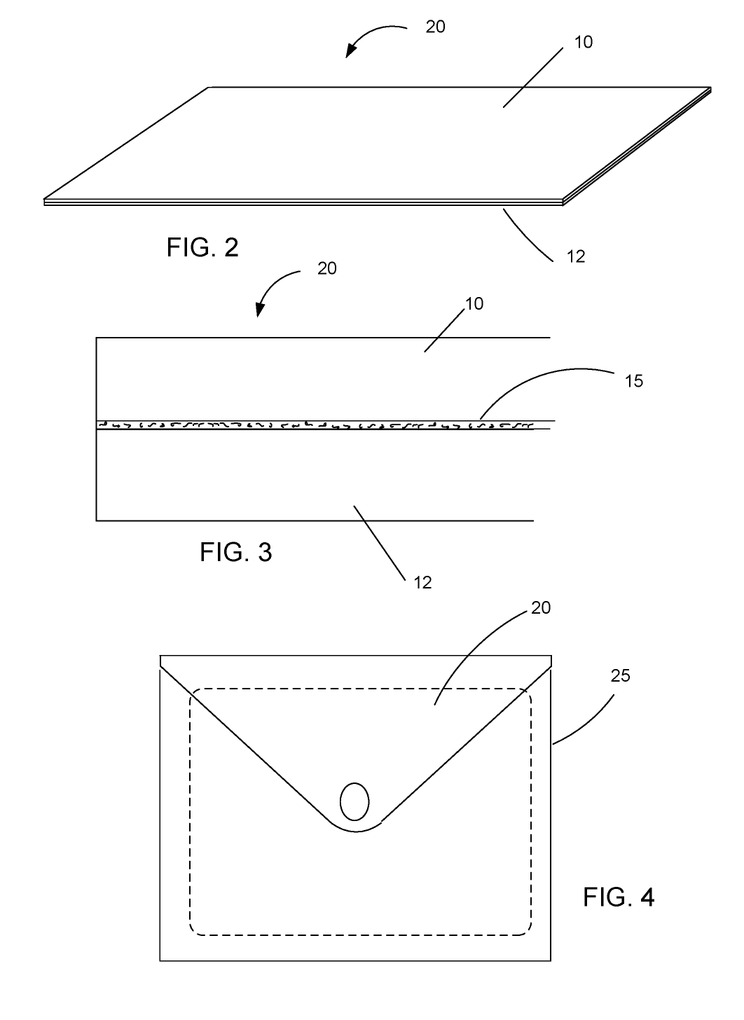

FIG. 2 shows a preferred protective film layer 10 adhered to release paper 12 to form protective film unit 20. In a preferred embodiment, protective film unit 20 is cut into a sheet that is approximately 12 inches long and 6½ inches wide.

In a preferred embodiment, protective film unit 20 is then folded into a shape that is a smaller size. In a preferred embodiment the smaller size is approximately 4 inches by 3¼ inches. Protective film unit 20 is then placed into a pouch for easy use and transportation by a consumer. For example, FIG. 4 shows pouch 25 containing folded protective film unit 20. In a preferred embodiment, the user will place pouch 25 into her purse and carry it there so that it is easily available when needed.

### Utilization of the Protective Film

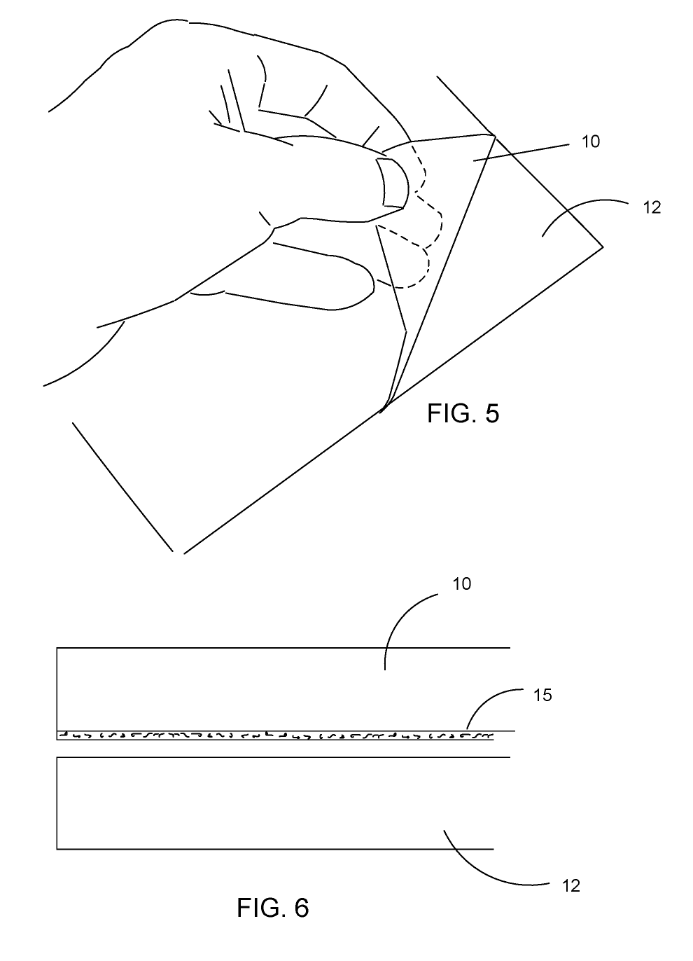

In FIG. 5 the user has removed protective film unit 20 from pouch 25, she has unfolded protective film unit 20 and is in the process of peeling protective film layer 10 from release paper 12. When protective film layer 10 has been completely pulled away from release paper 12, adhesive 15 will remain connected to protective film layer 10 (FIG. 6).

In FIG. 7 the user has adhered protective film layer 10 to the bottom of purse 50 utilizing adhesive 15. Protective film layer 10 will now protect purse 50 from any dirt, germs or impurities. When the user is done using protective film layer 10 for protection, the user may easily peel away protective film layer 10 from the bottom of purse 50. Adhesive 15 will remain attached to protective film layer 10, leaving purse 50 free from unwanted residue.

Although the above-preferred embodiments have been described with specificity, persons skilled in this art will recognize that many changes to the specific embodiments disclosed above could be made without departing from the spirit of the invention. For example, although the above description discussed the utilization of protective film layer 10 for protecting a purse, it should be understood that protective film layer 10 could be applied to a variety of bag types. This list of acceptable bag types includes, but is not limited to: handbags, diaper bags, totes, briefcases, laptop bags and luggage. Also, although it was stated above that in a preferred embodiment protective film layer 10 is approximately 2 mils thick, it should be understood that protective film layer 10 could be thicker or thinner in other preferred embodiments. Also, although it was stated above that protective film unit 20 is cut into a sheet that is approximately 12 inches long and 6½ inches wide, it should be understood that protective film unit 20 could be cut into a sheet of many different sizes depending upon the needs and wishes of the user. Therefore, the attached claims and their legal equivalents should determine the scope of the invention.

What is Claimed is:

1) A method for protecting the bottom of a bag from dirt, germs and grime, comprising the steps of:
A) adhering a protective film to release paper utilizing a tacky adhesive to form a protective film unit sheet,
B) folding said protective film unit sheet to a smaller size,
C) placing said folded protective film unit into a pouch,
D) placing said pouch with said protective film unit into said bag,
E) removing said protective film unit from said pouch,
F) unfolding said protective film unit,
G) peeling said protective film away from said release paper so that said adhesive remains attached to said protective film,
H) adhering said protective film to said bag bottom to protect said bag, and
I) removing said protective film from said bag.

2) The method as in claim 1, wherein said step of removing said protective film from said bag is done so that said adhesive remains attached to said protective film leaving said bag free from unwanted adhesive residue.

3) The method as in claim 1, wherein said protective film is a polyethylene film at least 2 mil thick.

4) The method as in claim 1, wherein said protective film unit sheet is approximately 12 inches by 6½ inches.

5) The method as in claim 1, wherein said adhesive is a tacky formulated acrylic adhesive remaining attached to said protective film.

6) The method as in claim 1, wherein said protective film unit is folded into a shape that is approximately 4 inches by 3¼ inches.

7) The method as in claim 1, wherein said bag is a purse.

8) The method as in claim 1, wherein said bag is a handbag.
